(19) United States
(12) Patent Application Publication
(10) Pub. No.: US 2010/0060718 A1
(43) Pub. Date: Mar. 11, 2010

(54) Measuring a hollow space by means of cylindrically symmetrical triangulation

(76) Inventors: Frank Forster, Munchen (DE); Claudio Laloni, Taufkirchen (DE); Gerhard Röhrlein, Lakeview Court, MA (US); Anton Schick, Velden (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/514,490

(22) PCT Filed: Nov. 8, 2007
(86) PCT No.: PCT/EP2007/062021

§ 371 Date: May 12, 2009

(30) Foreign Application Priority Data
Nov. 17, 2006 (DE) 10 2006 054 310.6

(51) Int. Cl. H04N 15/00; G06K 9/00

(52) U.S. Cl. 348/47; 348/49; 382/154; 348/E15.001

(57) ABSTRACT

An optical measuring device for a three-dimensional measuring of a hollow space formed within an object is provided. The optical measurement device has a light source, which is provided for emitting illumination light along an illumination beam path, and an optical deflection element, which spatially structures the radiated illumination light such that on an inside wall an illumination line forms, which extends along the longitudinal axis. The shape of the line is dependant on the size and shape of the hollow space. Further, the optical measuring device has a camera, which detects the illumination line via an imaging beam path at a triangulation angle. Through an appropriate evaluation of the image of the detected shape and size of the illumination line by the camera, the three-dimensional shape of the hollow space is determined.

### CROSS REFERENCE TO RELATED APPLICATIONS

This application is the US National Stage of International Application No. PCT/EP2007/062021 filed Nov. 8, 2007, and claims the benefit thereof. The International Application claims the benefits of German Patent Application No. 10 2006 054 310.6 DE filed Nov. 17, 2006, both of the Applications are incorporated by reference herein in their entirety.

### FIELD OF INVENTION

The present invention relates to an optical measuring device and to a method for three-dimensional measurement of a hollow space which is formed in an object. In particular, the invention relates to such an optical measuring device and to such a method for the three-dimensional measurement of the auditory canal of a live human or animal.

### BACKGROUND OF INVENTION

In order to produce custom-fit hearing devices, the shape of the outer and inner auditory canal must be detected and measured precisely. Hearing devices are modeled and adapted with the aid of corresponding three-dimensional data. This is the only means of ensuring that the hearing device can be worn in the ear without pressure or pain. In addition, it is functionally important for the gap between the ear and the hearing device to be as small as possible, since background noise via this route can otherwise impair the effect of the hearing device.

At present, determining the shape data is relatively unpleasant for the patient. A plastic material is injected into the ear and is then removed again after hardening. The shape impression obtained thus is sent to a laboratory. The impression is measured again in three dimensions in the laboratory. The hearing device is produced on the basis of the three-dimensional (3D) data obtained. However, the shape-impression method has the disadvantage that shrinkage of the plastic material is unavoidable, since the patient cannot be expected to bear the relatively unpleasant procedure involved in producing the shape impression over an extended period of time. The shape-impression method also has the disadvantage that the ear canal is not measured directly, but is only measured indirectly by measuring the shape impression. This results in inaccuracies in the finished hearing devices and hence to a corresponding reduction in comfort.

EP 1 661 507 A1 discloses a method for obtaining a three-dimensional image of the outer ear canal. The outer ear canal is detected using a video camera in this case, and the image data obtained is transferred to a service provider. Said service provider carries out a validation test with the data, and converts the data into geometric 3D data. The converted data can be utilized for producing custom-made hearing devices.

U.S. Pat. No. 6,751,494 B2 discloses a method for reconstructing the geometry of an inside wall of a hollow space. The hollow space can be the outer auditory canal of a patient, for example. In the case of the method described, an optical sensor is inserted into the auditory canal. At the same time, video signals are recorded which are transferred to a computer. The computer transforms the video signals into positional data which describes the inside wall of the hollow space. The three-dimensional structure of the hollow space is measured in this way.

### SUMMARY OF INVENTION

An object of the invention is to specify an optical measuring device and a method for the three-dimensional measurement of a hollow space which is formed in an object, wherein said device and method allow a measurement of the hollow space which is both particularly rapid and particularly accurate.

This problem is solved by the subject matter of the independent claims. Advantageous embodiments of the present invention are described in the dependent claims.

An optical measuring device for the three-dimensional measurement of a hollow space which is formed in an object is provided. In particular, the optical measuring device is suitable for the three-dimensional measurement of the auditory canal of a live human or animal. The described optical measuring device features (a) a light source which is provided for emitting an illumination light along an illumination beam path and (b) an optical deflection element which spatially structures the emitted illumination light such that at least one illumination line surrounding the longitudinal axis is generated on the inside wall, wherein the shape and/or position and/or extent of said line depends on the size and the shape of the hollow space. The described optical measuring device also features (c) a camera which detects the at least one illumination line at a triangulation angle via a mapping beam path.

The structuring of the illumination light can generate at least one illumination structure concentrically relative to a longitudinal axis, wherein said structure has the shape of a conical shell in each case and can be projected onto the inside wall of the hollow space. In this case, precisely one illumination line is assigned to each illumination structure.

The cited optical measuring device is based on the insight that a three-dimensional (3D) measurement of the hollow space can be carried out in a simple manner using a triangulation method which is modified in accordance with the invention, by means of an illumination that is structured in a cylindrically symmetrical manner and is projected onto the inside wall of the hollow space to be measured. In this case, the shape of the at least one projection line is detected by a camera which records a two-dimensional (2D) image of the projection ring or projection rings, said recording preferably being symmetrical relative to the longitudinal axis. On the basis of the deviations or distortions of the detected projection shape of symmetrical annular shapes, these being concentric relative to the longitudinal axis, the inside wall of the hollow space can be measured in 3D.

In comparison with three-dimensional distance sensors, by means of which only one measurement point is illuminated and the height position of the illuminated measurement point is detected in each case, the described optical measuring device has the advantage that a multiplicity of measurement points arranged along the longitudinal axis are automatically measured quasi simultaneously. This results in a significantly increased sampling speed overall.

It is preferable to generate a plurality of illumination structures, each of the generated illumination structures having the shape of a conical shell. In this way, it is possible further to increase the number of measurement points that can be detected simultaneously by means of a single camera image.

In the case of a cylindrical hollow space which extends symmetrically around the longitudinal axis of the optical measuring device, projection rings are produced which are formed or arranged concentrically relative to the longitudinal axis. In the case of a cylindrical hollow space extending around a cylindrical axis that has a parallel offset relative to the longitudinal axis of the optical measuring device, warped projection rings are produced which have a wavy shape relative to the longitudinal axis. In this case, adjacent projection lines in a first wall region of the inside wall, which region is further away from the longitudinal axis than a second wall region, have a greater distance between them. This occurs because, as a result of the conical expansion of the individual illumination structures, adjacent projection lines grow further apart as the distance from the longitudinal axis increases. It is therefore clear that both the deviation of the 3D shape of the projection lines detected by the camera from a perfect annular shape, and the distance between adjacent projection lines provide information about the 3D contour of the hollow space.

At this point, it is noted explicitly that an illumination structure or a possibly deformed illumination line already provides 3D information relating to the size and the shape of the hollow space to be measured. It is nonetheless advantageous, particularly in terms of the measurement speed, to structure the illumination light that is emitted from the light source in a plurality of conically widened illumination structures.

The detection of the illumination lines at a triangulation angle means that the beam path of the mapping light with the beam path of the illumination light, i.e. with the relevant opening angle of the conical illumination structure, forms an angle other than 0°. This angle is referred to as a triangulation angle. The greater the triangulation angle, the higher the accuracy of the 3D position specification.

In other words, this means that a light spot which is generated from a specific illumination direction is observed from a different direction. The triangulation angle is defined by the angle which spans these two directions. The knowledge of the triangulation angle allows the height or the lateral position of the light spot to be specified in relation to the longitudinal axis of the described optical measuring device in a known manner.

It is noted that the described illumination structures are conical shell surfaces which open outward starting from the longitudinal axis of the optical measuring device at various opening angles. In this case, the cone points can coincide at a virtual source point, wherein said source point lies on the longitudinal axis. In this context, real source point signifies that all illumination structures start at least approximately from a source point on the longitudinal axis. This is therefore the case when the fanned out illumination beam path coincides with the longitudinal axis in the region of the optical deflection element.

However, the illumination structures can also go beyond a circular ring which is arranged concentrically around the longitudinal axis. In particular, this occurs when the optical axis of the mapping beam path coincides with the longitudinal axis at least in partial regions, and the illumination light is routed to the optical deflection element outside of the longitudinal axis.

The described optical measuring device has the advantage that, for the purpose of 3D measurement, no moving parts and in particular no moving optical components are required within the measuring device. This means that the optical measuring device can be produced at comparatively low cost and moreover that the reliability of the measuring device is also very high in real operating conditions.

It is noted that, for the purpose of measuring larger hollow spaces, the whole measuring device can be pushed, preferably along the longitudinal axis, by means of a linear movement. The partial images recorded in the context of such a movement can be combined again by means of suitable image processing methods. Such a combination is often also referred to as “stitching”.

Suitable image processing methods can include, for example, those in which the combination of the above-cited partial images takes place on the basis of the comparison of features within these partial images. In particular, the partial images can be recorded in such a way that the image contents at least partially overlap, wherein the combination of the partial images then takes place by comparing the relevant overlapping regions, in particular by comparing selected features within the regions which overlap in each case.

In particular, e.g. in conjunction with the previously cited method for combining the partial images, provision can additionally be made for combining the partial images without using any data that relates to the spatial position of the optical measuring device within the hollow space. In particular, provision can be made for the partial images to be combined without using any data that relates to the spatial position of parts of the optical measuring device, e.g. the optical deflection element, within the hollow space. Such a method has the advantage that the normally resource-intensive detection of the spatial position of the measuring device or parts thereof is not necessary and can be omitted completely under certain conditions.

The depth measurement region, i.e. the region along the longitudinal axis in which the 3D measurement can be carried out, depends on the number and the angle separation of the individual illumination structures with reference to the relevant cone opening angles. The greater this number and the greater this angle separation, the greater the measurement region of the optical measuring device. The smaller the number of generated illumination structures or the smaller the number of projected illumination lines, the more individual recordings must be combined for the purpose of measuring a hollow space.

Furthermore, the described optical measuring device has the advantage that it can be realized within a small design format shape. At least one end of the optical measuring device, on the object side, can therefore be inserted into comparatively small or thin hollow spaces. This allows the optical measuring device to be used as a mobile device, e.g. for measuring the ear canal of a live human or animal. By virtue of such direct scanning or sampling, it is possible to penetrate further into the auditory canal in comparison with impression shapes, and also to measure the auditory canal three-dimensionally in the vicinity of the tympanic membrane. As a result of this, hearing devices can be shaped in such a way that they can be positioned in the vicinity of the tympanic membrane. In this way, the efficiency of such hearing devices is significantly increased.

Further advantages of the described optical measuring device are derived in connection with the measurement of the human ear canal in particular. For example, the shape impression which is typically very unpleasant for a patient is avoided by virtue of the direct 3D scanning. Moreover, the 3D data obtained by means of the direct 3D scanning is clearly more accurate in comparison with the 3D measurement of a shape impression, since a shrinkage which normally occurs in the case of a shape-impression material does not affect the accuracy of the direct 3D measurement.

According to an embodiment of the invention, the optical measuring device additionally features an analysis unit, which is connected in series after the camera and is configured such that the size and the shape of at least part of the hollow space can be determined automatically by means of image processing of the at least one illumination line detected by the camera. The described analysis unit therefore advantageously allows automatic image analysis of the 2D images detected by the camera, such that 3D data relating to the measured hollow space can be directly provided for further data processing as an output variable of the optical measuring device.

In connection with the measurement of the human ear canal, the 3D scanning and automatic analysis described above have the advantage that the 3D data which is obtained can be sent directly, i.e. in particular electronically, to special laboratories for the purpose of manufacturing an optimally customized hearing device.

According to a further exemplary embodiment of the invention, the optical deflection element has a cylindrically symmetrical shape in relation to the longitudinal axis. This has the advantage that a uniform distribution of intensity is guaranteed along the outer circumference of each conical shell.

The optical deflection element is an optically diffractive element and/or an optically refractive element. This allows structuring of the illumination light in a simple manner.

It is noted that not just monochromatic illumination light can be used, and can be generated e.g. by a laser, in particular a laser diode or light-emitting diode. The illumination light can also be generated by a light source having a wide-band spectrum, such that the illumination structures projected onto the inside wall are not just structured spatially but also spectrally, i.e. with regard to their color. The color structuring can also be utilized for the purpose of precisely determining the shape of the hollow space to be measured.

The optical deflection element is an optical grating which features a substructure. In this case, the optical deflection element can be a so-called Daman grating which features a particularly advantageous substructure, such that the light intensity is distributed selectively and possibly to a large extent uniformly at specific orders of diffraction. In particular, the available light intensity can be distributed at high orders of diffraction, such that as little illumination light as possible is directed at low orders of diffraction which only run at a small angle relative to the longitudinal axis. Consequently, the angle at which the illumination lines are projected onto the inside wall of the hollow space to be measured is comparatively large in relation to the longitudinal axis of the described optical measuring device. This again has positive effects on the measuring accuracy of the optical measuring device.

In this context, the term optical grating signifies that the grating intervals lie in the order of magnitude of the wavelengths or the wavelength spectrum of the illumination light.

The optical measuring device also features a projection lens system which is arranged in the illumination beam path. This has the advantage that the illumination light can be focused in such a way that the illumination lines can be shown as sharply as possible on the inside wall of the hollow space to be measured, and can therefore be detected as sharp structures by the camera. The optimal choice of the focal length of this lens system therefore depends on the fanning out of the illumination beam which hits the lens system, the optical path length of the illumination light between the lens system and the optical deflection element, and the optical path length between the optical deflection element and the inside wall. This means that the focal length of this lens system should not depend solely on the design of the described optical measuring device, but also on the approximate expected size of the hollow space that is to be measured.

The optical measuring device additionally features a beam splitter which is arranged at an oblique angle on the longitudinal axis and which redirects the illumination beam path such that an object-side section of the illumination beam path runs parallel with the longitudinal axis, or which redirects the mapping beam path such that an image-side section of the mapping beam path runs at an angle to the longitudinal axis.

In this context, oblique angle means that the beam splitter is arranged at an angle which is not equal to 0° and is not equal to 90° relative to the longitudinal axis. The beam splitter is preferably tilted at an angle of 45° relative to the longitudinal axis, such that the illumination beam path or the mapping beam path has a bend of 90°.

At least a section of the illumination beam path, in which the illumination light is routed parallel with the longitudinal axis, is shaped around the mapping beam path which runs centrically in the longitudinal axis. In this case, the illumination beam path in cross section can be arranged perpendicularly to the longitudinal axis in an annularly symmetrical manner, i.e. concentrically around the longitudinal axis or the mapping beam path. This means that an illumination beam that is concentric relative to the longitudinal axis hits the optical deflection element, which is likewise formed symmetrically relative to the longitudinal axis. For example, a ring grating is suitable as an optical deflection element.

At this point it is noted explicitly that the described measuring device can also be realized in other ways in respect of the spatial arrangement of illumination beam path and mapping beam path. For example, the mapping beam path can be shaped around the illumination beam path which runs centrically in the longitudinal axis. In this case, the illumination lines which are projected onto the inside wall of the hollow space that is to be measured are detected by means of an annular aperture which is preferably arranged concentrically relative to the longitudinal axis. In this case, the mapping beam path can be realized e.g. by means of optical fibers which are spatially distributed around the longitudinal axis in a corresponding manner and together allow an image transfer.

It is further noted that the illumination beam path and the mapping beam path can also run coaxially to some extent. For the purpose of the 3D measurement based on the principle of triangulation, it is actually sufficient if on the object side, i.e. in the vicinity of the illumination lines that are to be measured, the illumination beam path and the mapping beam path are spatially separated such that a triangulation angle is established. An object-side splitting of illumination beam path and the mapping beam path can be done e.g. by means of suitable beam splitters or by means of an optical fiber whose object-side end is split into two spatially separated part ends.

The optical measuring device additionally features a light-conducting entity which is arranged in the mapping beam path and is provided for transferring a two-dimensional image of the illumination lines to the camera.

A rod lens arrangement which is relatively rigid mechanically, such as that used in the case of e.g. endoscopes, can be used as a light-conducting entity. An endoscopic system based on a gradient lens system, in which the refractive index changes depending on the radius, can also be used as a light-conducting entity. Curvature of the light beams can therefore be achieved within the light-conducting entity, such that the camera can detect mapping beams from a wide range of angles as a result.

A so-called Hopkins lens system, which mechanically is likewise a largely rigid optical arrangement, can also be used for the light-conducting entity. A Hopkins lens system can be a type of glass tube, for example, in which lenses of air are inserted, such that particularly detailed inspection is possible in the case of endoscopic examinations. This advantage of the particularly detailed inspection also results in particularly high accuracy and reliability of the 3D measurement in the case of the described optical measuring device.

Also suitable as a light-conducting entity is a so-called image light conductor which comprises a multiplicity of individual optical fibers or glass fibers. An image light conductor has the advantage that it is flexible, and therefore the optical measuring device can be realized in a design format which is at least partially flexible. This allows precise measurement of a hollow space even in the case of curved hollow spaces, into which a rigid measuring device cannot be inserted.

The optical measuring device additionally features a mapping lens system which is arranged on the object side in the mapping beam path. The mapping lens system preferably has a particularly short focal length, such that the illumination lines projected on the inside wall can be detected by a camera at a large mapping angle relative to the longitudinal axis. The separation between adjacent illumination lines is therefore particularly clearly apparent. A lens system having a short focal length of this type is often referred to as a “fish-eye lens system” and allows a very wide range of angles to be detected.

The expression “on the object side” in this context is understood to mean that the mapping lens system is located close to the illumination lines that are to be detected. The illumination lines actually represent the object that is to be detected in the case of the described optical measuring device.

It is noted that the triangulation angle is determined in particular by the distance of the mapping lens system from the optical deflection element. The relative positioning of the mapping lens system and the optical deflection element therefore determines, as set forth above, the resolution of the described optical measuring device.

The optical measuring device additionally features a fixable mechanism, by means of which the optical measuring device can be fixed to the object.

In as much as the fixable mechanism allows a defined displacement of the optical measuring device, in particular along the longitudinal axis, it is therefore possible to carry out a plurality of measurements in which the optical measuring device is inserted at different depths into the hollow space that is to be measured. Consequently, an elongated hollow space such as e.g. a human auditory canal can also be measured three-dimensionally along its entire length.

It is noted that the optical measuring device can also be realized in a miniaturized design format. For example, the optical measuring device including the camera and the light source can therefore be so small that the whole optical measuring device can be inserted into an auditory canal for the purpose of measuring said auditory canal. This has the advantage that, for the purpose of three-dimensional measurement of the human auditory canal, which features a particularly pronounced curve at one location, the ear canal need not be distorted or need only be distorted slightly.

The optical measuring device additionally features a marking which can be detected by at least two external cameras. This has the advantage that the position of the optical measuring device can be precisely determined by means of suitable image processing of the images detected by both cameras. In this case, known methods which are based on the principle of triangulation can likewise be used for determining the position. Of course, the two cameras are spatially arranged such that the marking can be detected from different viewing directions in this case.

Provision is preferably made for at least two markings, such that both the position and the orientation of the optical measuring device can be determined by applying suitable photogrammetric algorithms to the images recorded by the two cameras.

Further, a method for the three-dimensional measurement of a hollow space which is formed in an object, in particular for the three-dimensional measurement of the auditory canal of a live human or animal is provided. The method has the following steps: (a) introducing at least one object-side part of an above-cited optical measuring device into the hollow space that is to be measured; (b) structuring the illumination light by means of the optical deflection element, such that at least one illumination line surrounding the longitudinal axis is generated on the inside wall of the hollow space; (c) detecting the at least one illumination line by means of a camera; and (d) analyzing the distortion of the at least one detected illumination line.

The cited method is based on the insight that the projection of an illumination line which is structured in a cylindrically symmetrical manner onto the inside wall of the hollow space to be measured allows a rapid and at the same time precise measurement of the hollow space, provided the detection of the at least one generated illumination line takes place at a triangulation angle other than 0°. Both the size and the shape of the hollow space can be measured from the distortion of the at least one illumination line in a two-dimensional image which is detected by the camera.

According to an exemplary embodiment of the invention, the method additionally comprises the following steps: (a) displacing the optical measuring device; (b) restructuring the illumination light by means of the optical deflection element, such that at least one further illumination line surrounding the longitudinal axis is generated on the inside wall of the hollow space; (c) detecting the at least one further illumination line by means of the camera; and (d) analyzing the distortion of the at least one further detected illumination line.

In this way, even an elongated hollow space can be completely measured by means of a successive recording of a plurality of detection regions which are displaced relative to each other. For this purpose, the optical measuring device can obviously be displaced repeatedly, in principle any number of times, along a predetermined section. Provided adjacent detection regions have a certain overlap, identical structures of the ear can be recognized in an auditory canal that is to be measured, for example, and the corresponding images can be aligned relative to each other by means of image processing. An auditory canal having a length of approximately 4 cm can therefore be fully measured in 3D using 100 to 1,000 partially overlapping individual measurements, depending on the size of the detected partial volumes.

According to a further exemplary embodiment of the invention, the optical measuring device is displaced from an inner measuring position towards an outer measuring position. In this context, inner measuring position means that the corresponding detection region of the optical measuring device lies further inside the hollow space to be measured than the detection region which is assigned to the outer measuring position of the optical measuring device.

When measuring an auditory canal, this means that the optical measuring device is firstly inserted deep into the ear canal, and is slowly withdrawn from the ear canal after a first measurement. A measurement of the auditory canal in which the optical measuring device is only displaced towards the outside, has the advantage that the ear canal is only deformed slightly and in a defined manner by a measuring head which rubs on the inside wall of the ear channel. In comparison with the case in which the optical measuring device is inserted inwards toward deeper regions of the auditory canal and hence compresses the tissue of the ear canal due to friction, a slow withdrawal of the measuring head rubbing against the inside wall of the ear canal causes significantly less deformation of the auditory canal to be measured.

The method additionally comprises the following step: inserting an elastic membrane featuring an optically detectable structure between the optical measuring device and the inside wall of the hollow space to be measured, wherein the elastic membrane lies flat against the inside wall. In this case, the structure is preferably formed such that it can easily be recognized during the image analysis of the images recorded by the camera. The structure can include a multiplicity of dot-shaped marks, for example.

The structure can also feature different markings, such that precise and in particular unambiguous image assembly is possible.

The use of an optically structured membrane has the advantage that individual errors do not accumulate during a combined analysis of different image sequences. In connection with the three-dimensional measurement of an auditory canal, the structured membrane has the advantage that sufficient recognizable structures for the image assembly are present directly on the skin surface in the auditory canal.

Use of the described elastic membrane for measuring the auditory canal also has the advantage that hygiene requirements are automatically satisfied during the auditory canal measurement. This applies likewise if a new membrane is used for each auditory canal measurement. Furthermore, the membrane has the advantage that interference effects caused by hairs are largely eliminated.

The method additionally features the following step: inflating the inserted membrane. This has the advantage that the structured membrane lies flush against the inside wall of the hollow space to be measured. When measuring auditory canals, this has the advantage that 3D measurement of collapsed auditory canals is also possible, wherein patterns of the original auditory canal shape are produced. Consequently, mechanically suitable hearing devices or otoplastics for collapsed auditory canals can also be manufactured on the basis of the 3D measurement.

### BRIEF DESCRIPTION OF THE DRAWINGS

Further advantages and features of the present invention are derived from the following exemplary description of currently preferred embodiments. The drawing comprises schematic illustrations, in which:

FIG. 1a shows a cross-sectional view of a cylindrically symmetrical optical measuring device,

FIG. 1b shows a camera image which shows four images of corresponding illumination lines that are projected onto the inside wall of the hollow space,

FIG. 1c shows a front view of the object-side end of the optical measuring device which is illustrated in FIG. 1,

FIG. 1d shows the illumination light and mapping light beam paths which are formed at the object-side end of the optical measuring device illustrated in FIG. 1, wherein said beam paths determine the triangulation angles,

FIG. 2a shows the diffraction rings which are generated by a ring grating featuring a substructure and projected onto the inside wall of the hollow space, and

FIG. 2b shows a perspective partial sectional view of a hollow space to be measured, with the illumination lines which are projected onto the inside wall of the hollow space.

At this point, it remains to be noted that the reference numerals relating to identical or corresponding components in the drawing differ only in their first digit.

### DETAILED DESCRIPTION OF INVENTION

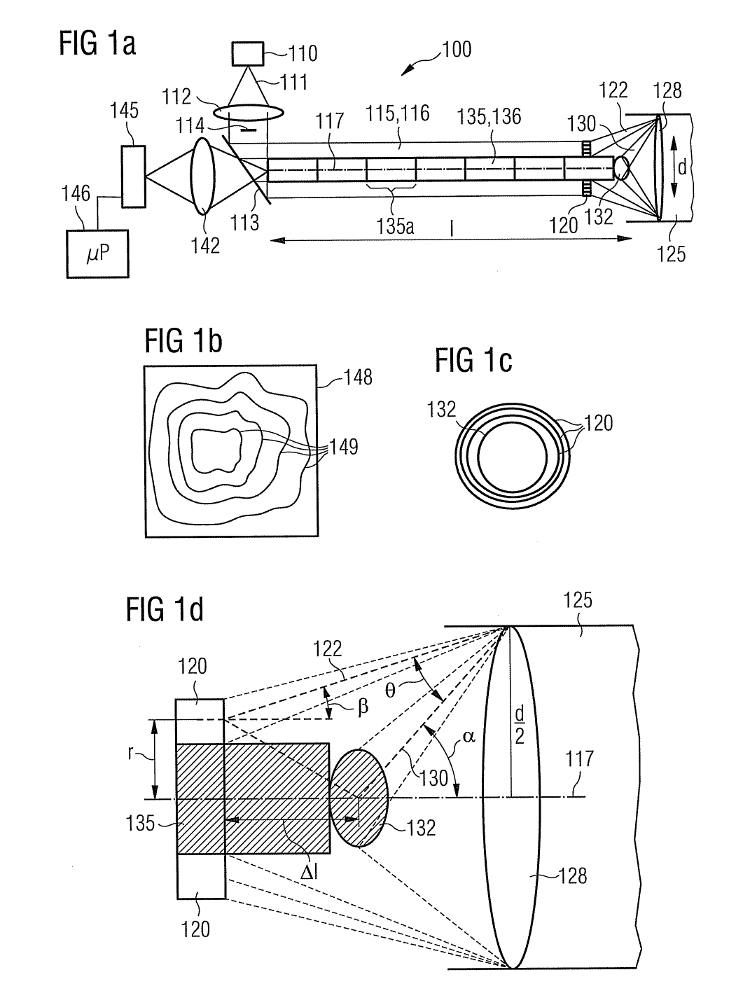

FIG. 1a shows a cross-sectional view of an optical measuring device 100 as per an exemplary embodiment of the invention. The optical measuring device 100 has a cylindrically symmetrical shape relative to a longitudinal axis 117.

The optical measuring device 100 features a light source 110, which is a laser diode 110 according to the exemplary embodiment illustrated here. It is obvious that other light sources such as a light-emitting diode, for example, can also be used. The laser diode 110 emits monochromatic illumination light 111, which hits a projection lens system 112 that expands the illumination beam 111. The expanded illumination beam 111 hits a beam splitter 113 which is oriented at an angle of 45° relative to the longitudinal axis 117, such that at least part of the illumination light 111, depending on the reflection capabilities of the beam splitter 113, is input into a hollow cylinder 115 which is arranged symmetrically relative to the longitudinal axis 117. In order to prevent interference of the illumination light 111 in the central part of the hollow cylinder 115, an optical shielding element 114 is arranged between beam splitter 113 and laser diode 110.

The illumination light that is redirected by the beam splitter 113 is routed along an illumination beam path 116. The illumination beam path 116 is cylindrically symmetrical relative to the longitudinal axis 117. At an object-side end of the optical measuring device 100, the illumination light hits an optical deflection element 120 which likewise has a cylindrically symmetrical shape and is arranged in a cylindrically symmetrical manner around the longitudinal axis 117. The optical deflection element 120 can be an optically diffractive element or an optically refractive element. According to the exemplary embodiment illustrated here, the optical deflection element is a ring grating 120.

The ring grating 120 features a substructure, such that the incident light intensity is preferably directed at high orders of diffraction. In this way, the illumination light is spatially structured such that a plurality of illumination structures 112 are produced concentrically relative to the longitudinal axis 117, and have the shape of a conical shell 122 in each case and are projected onto the inside wall of a hollow space 125 that is to be measured. For reasons of clarity, only one illumination structure 122, which is assigned to a high order of diffraction, is illustrated in the FIG. 1a.

According to the exemplary embodiment illustrated here, the hollow space to be measured is an auditory canal 125 of a patient. The auditory canal 125 typically has a diameter d of approximately 4 mm.

It is noted, however, that the measuring device 100 can also be used for measuring other hollow spaces. For example, the three-dimensional shape of drilled holes can be measured precisely, before it is possible to select perfectly fitting rivets for a particularly reliable rivet joint, e.g. in the context of aircraft construction.

The projection of the illumination structure 122 on the inside wall of the hollow space 125 produces a closed illumination line 128, whose shape depends on the size and shape of the hollow space 125. In this case, the sharpness of the illumination line 128 depends on the focusing of the illumination structures 122 on the inside wall. For this reason, the focal length of the projection lens system 112 can be adjusted in such a way that sharp illumination lines 128 are produced on the inside wall of the hollow space, given an approximate expected size of the hollow space to be measured.

The size and the shape of the individual illumination lines 128 are detected by a camera 145. This takes place via a mapping light 130 which starts from the illumination lines 128. This mapping light 130 is collected by means of a mapping lens system 132 which has a particularly short focal length. The mapping lens system 132 can also be referred to a fish eye due to the extremely wide reception angle.

The mapping light 130 which is collected by the mapping lens system 132 is routed to the image-side end of the optical measuring device 100 by means of a light-conducting entity 135. According to the exemplary embodiment illustrated here, the light-conducting entity 135 is a rod lens arrangement 135, which is also used in medical engineering in endoscopic devices, for example. The second mapping lens system can be formed as a unitary part with the rod lens arrangement 135, by providing for the corresponding end boundary surface of a corresponding rod lens, said surface being oriented towards the hollow space, to have an extremely pronounced curvature.

The rod lens arrangement 135 features a plurality of individual rod lenses 135a, which together have a length l of approximately 50 mm. It is obvious that the rod lens arrangement 135 can also have any other desired length. The rod lens arrangement 135 can also be a so-called Hopkins lens arrangement.

The rod lens arrangement 135 therefore defines a mapping beam path 136 which extends along the longitudinal axis 117 towards the image-side end of the optical measuring device 100. The mapping beam path 136 and the illumination beam path 116 are arranged in each case in a cylindrically symmetrical manner relative to the longitudinal axis 117, wherein the illumination beam path 116 is situated outside of the mapping beam path 136.

A different design format of the optical measuring device is obviously conceivable, wherein the mapping beam path runs outside of the illumination beam path. In each case, a spatial separation of illumination light 122 and mapping light 130 must occur at the latest at the object-side end of the optical measuring device 100, in order that the projected illumination lines 128 can be detected at a triangulation angle and hence the 3D contour of the hollow space 125 can be determined. A triangulation angle is always established when the illumination, i.e. the generation of the illumination lines 128 in this case, occurs at a different angle to the observation, i.e. in this case the mapping of the illumination lines 128 towards the camera 145.

The mapping light 130, which is routed in the rod lens arrangement 135, hits the beam splitter 113. The beam splitter is penetrated with only a certain parallel offset by at least part of the mapping light 130. This parallel offset depends on the thickness, the refractive index and the angle setting of the beam splitter 142 relative to the longitudinal axis 117. The remainder of the mapping light 130 is reflected on the beam splitter and hits the optical shielding element 114 or the laser diode 110 as dissipated light.

The part of the mapping light 130 which passes through the beam splitter 113 hits a mapping lens system 142 and is mapped onto the camera 145 by said system. The camera 145 therefore records a camera image 148 which, depending on the shape of the hollow space 125, shows images 149 of the illumination lines 128, these being distorted in particular in the boundary region of the camera image 148. FIG. 1b shows such a camera image 148, for example, in which a total of four images 149 of corresponding illumination lines 128 projected onto the inside wall of the hollow space 125 can be recognized. On the basis of a quantitative analysis of this distortion, which takes place in an analysis unit 146 that is connected in series after the camera 145, it is possible to determine both the shape and the size of the hollow space 125.

FIG. 1c shows a front view of the object-side end of the optical measuring device 100. It is possible to recognize the mapping lens system 132, which is surrounded by the ring grating 120.

In a cross-sectional illustration, FIG. 1d shows the beam paths of the illumination light 122 and the mapping light 130, said beam paths being formed at the object-side end of the optical measuring device 100. For a specific illumination line 128, which is illustrated in FIG. 1d, an average projection angle or illumination angle β is produced relative to the longitudinal axis 117. In this case, it is assumed that the illumination light 122 emerges from the annular ring grating 120.

The ring grating 120 has an average radial distance r from the longitudinal axis 117. In a corresponding manner, a mapping angle α is derived relative to the longitudinal axis 117 for the illustrated illumination line 128. In this case, it is assumed that the mapping light 130 is collected by the mapping lens system 132 which is arranged centrically on the longitudinal axis 117.

The triangulation angle θ is derived from the difference between the two angles α and β(θ=α−β). It is evident from FIG. 1d that this triangulation angle θ obviously also depends on the longitudinal distance Δ1. This longitudinal distance Δ1 is derived from the distance, parallel with the longitudinal axis 117, between the ring grating 120 and the mapping lens system 132.

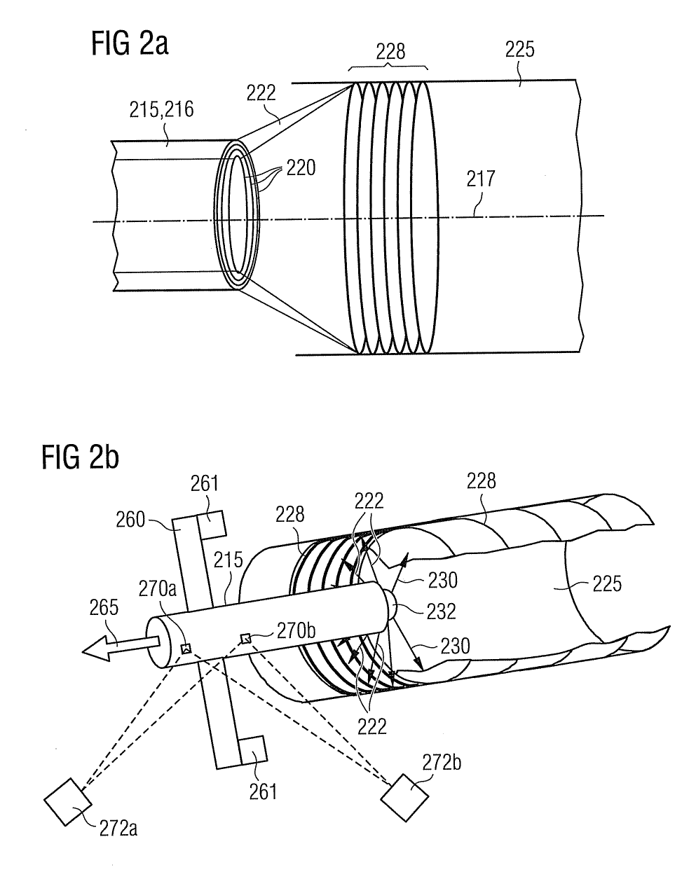

FIG. 2a shows a ring grating 220 which is arranged at the end of a hollow cylinder 215. An illumination beam 216, which is offset relative to the longitudinal axis 217, is routed in the hollow cylinder 215 and is spatially structured in a cylindrically symmetrical manner by the ring grating 220, such that illumination structures 222 having the shape of a conical shell are generated. The illumination structures 222 are projected onto the inside wall of a hollow space 225 or auditory canal 225. As described above, illumination lines 228 which completely surround the longitudinal axis 217 are produced as a result.

According to the exemplary embodiment illustrated here, the ring grating 220 has a substructure which is formed such that the intensity of illumination light 216 striking the ring grating 220 is selectively divided into six orders of diffraction having largely identical intensity. In this case, the lower-order diffraction structures have no or only negligible intensity. In particular, the zeroth order of diffraction which runs parallel with the longitudinal axis 217 is suppressed. As a result, six diffraction lines 228 are generated on the inside wall of the hollow space 225. The spatial measurement of these illumination lines 228 takes place analogously, as described above with reference to FIG. 1a.

FIG. 2b shows a perspective partial sectional view of a hollow space 225 to be measured, with the illumination lines 228 which are projected onto the inside wall of the hollow space 225. The illumination light generating the illumination lines 228 is identified by the reference numeral 222. The ring grating is not shown for reasons of clarity. The hollow cylinder 215, in which the illumination light 216 is routed to the ring grating in a cylindrically symmetrical manner, can also be recognized.

The illumination lines 228 are detected by the camera (not shown) using the second mapping lens system 232, i.e. by collecting the corresponding mapping light 230 which is given off by the illumination lines 228.

The beam paths of the illumination light coming from the laser diode which is used as a light source, and of the mapping light as far as the camera, run as described above with reference to FIG. 1. The image analysis also takes place correspondingly.

In order to allow complete measurement of even an elongated hollow space 225, it is possible successively to measure a plurality of image recordings of detection regions within the hollow space 225, said detection regions being displaced relative to each other. In this case, the optical measuring device can be displaced, in principle any number of times, along a predetermined section. Provided adjacent detection regions have a certain overlap, identical structures of the ear can be recognized in an auditory canal that is to be measured, for example, and the corresponding images can be aligned relative to each other by means of image processing.

A defined displacement of the optical measuring device can easily be realized by using a fixable mechanism 260 which can be fixed to the object in a defined manner by means of fixing elements 261, wherein the hollow space 225 to be measured is formed within said object. The fixable mechanism 260 then allows a defined movement 265 of the optical measuring device, preferably along the longitudinal axis. By means of a distance measuring system (not shown), the position of the optical measuring device relative to the object, e.g. the head of a patient, can be determined accurately at all times and taken into consideration during the analysis of the images recorded by the camera.

The position of the optical measuring device can likewise be determined by means of the optical detection, based on the principle of triangulation, of a marking 270a. In this case, the marking 270a is detected by two cameras, a first camera 272a and a second camera 272b, which are arranged at an angle to each other. The spatial position of the marking 270a can be determined precisely by means of a correspondingly combined image analysis of the images detected by both cameras 272a, 272b.

It is noted that the optical measuring device can also be equipped with a second marking 272b. Consequently, it is possible to determine both the position and the orientation of the optical measuring device by applying suitable photogrammetric algorithms to the images recorded by the two cameras 270a, 270b.

It is further noted that the embodiments described here represent only a limited selection of possible variants of the invention. The features of individual embodiments can be combined as appropriate, for example, and therefore a multiplicity of different embodiments is considered to be clearly disclosed for a person skilled in the art on the basis of the explicit variants here.

1.-17. (canceled)

18. An optical measuring device for a three-dimensional measurement of a hollow space formed in an object, comprising:
a light source for emitting an illumination light along an illumination beam path;
an optical deflection element which spatially structures the emitted illumination light such that an illumination line surrounding the longitudinal axis is generated on an inside wall; and
a camera configured to detect the illumination line at a triangulation angle via a mapping beam path.

19. The optical measuring device as claimed in claim 18, further comprising:
an analysis unit connected in series after the camera and configured such that the size and the shape of a part of the hollow space is determined automatically by image processing of the illumination line detected by the camera.

20. The optical measuring device as claimed in claim 18, wherein the optical deflection element has a cylindrically symmetrical shape relative to the longitudinal axis.

21. The optical measuring device as claimed in claim 18, wherein the optical deflection element is an optically diffractive element.

22. The optical measuring device as claimed in claim 18, wherein the optical deflection element is an optically refractive element.

23. The optical measuring device as claimed in claim 21, wherein the optical deflection element is an optical grating which features a substructure.

24. The optical measuring device as claimed in claim 22, wherein the optical deflection element is an optical grating which features a substructure.

25. The optical measuring device as claimed in claims 18, further comprising:
a projection lens system which is arranged in the illumination beam path.

26. The optical measuring device as claimed in claim 18, further comprising:
a beam splitter, arranged at an oblique angle on the longitudinal axis, which redirects the illumination beam path such that an object-side section of the illumination beam path runs parallel with the longitudinal axis.

27. The optical measuring device as claimed in claim 18, further comprising:
a beam splitter, arranged at an oblique angle on the longitudinal axis, which redirects the mapping beam path such that an image-side section of the mapping beam path runs at an angle to the longitudinal axis.

28. The optical measuring device as claimed in claim 18, wherein a section of the illumination beam path, in which the illumination light is routed parallel with the longitudinal axis, is shaped around the mapping beam path running centrically in the longitudinal axis.

29. The optical measuring device as claimed in claim 18, further comprising:
a light-conducting entity arranged in the mapping beam path and provided for transferring a two-dimensional image of the illumination lines to the camera.

30. The optical measuring device as claimed in claim 18, further comprising:
a mapping lens system arranged on the object in the mapping beam path.

31. The optical measuring device as claimed in claim 18, further comprising:
a mechanism configured to fix the optical measuring device to the object.

32. The optical measuring device as claimed in claim 18, further comprising:
a marking which is detected by at least two external cameras.

33. A method for a three-dimensional measurement of a hollow space formed in an object, comprising:
introducing at least one object-side part of an optical measuring device into the hollow space to be measured, the optical measuring device having
a light source for emitting an illumination light along an illumination beam path;
an optical deflection element which spatially structures the emitted illumination light such that an illumination line surrounding the longitudinal axis is generated on an inside wall; and
a camera configured to detect the illumination line at a triangulation angle via a mapping beam path;
structuring the illumination light by the optical deflection element, such that an illumination line surrounding the longitudinal axis is generated on an inside wall of the hollow space;
detecting the illumination line by a camera; and
analyzing a distortion of the detected illumination line.

34. The method as claimed in claim 33, further comprising:
displacing the optical measuring device;
restructuring the illumination light by the optical deflection element such that a further illumination line surrounding the longitudinal axis is generated on the inside wall of the hollow space;
detecting the further illumination line by the camera; and
analyzing the distortion of the further detected illumination line.

35. The method as claimed in claim 34, wherein the optical measuring device is displaced from an inner measuring position towards an outer measuring position.

36. The method as claimed in claim 14, further comprising:
inserting an elastic membrane, which has an optically detectable structure, between the optical measuring device and the inside wall of the hollow space to be measured, wherein the elastic membrane lies flat against the inside wall.

37. The method as claimed in claim 36, further comprising:
inflating the inserted membrane.
